(19) United States
(12) Patent Application Publication
(10) Pub. No.: US 2009/0274992 A1
(43) Pub. Date: Nov. 5, 2009

(54) PNEUMATIC HANDHELD MEDICAL DEVICE WITH REDUCED NOISE

(76) Inventor: Yong W. Kim, San Diego, CA (US)

Correspondence Address: NYDEGGER & ASSOCIATES, 348 OLIVE STREET, SAN DIEGO, CA, 92103, US

(21) Appl. No.: 12/112,335

(22) Filed: Apr. 30, 2008

(51) Int. Cl. A61C 1/05; A61C 1/04

(52) U.S. Cl. 433/132; 433/141

(57) ABSTRACT

A handheld pneumatic medical device, such as a dentist handpiece, is provided for rotating a bur about an axis. Importantly, the device utilizes the boundary layer effect to transfer energy from the fluid flow to rotation of the bur. As a result, the device is operated without creating high decibel noise. Structurally, the device includes a housing defining a chamber, and a hub mounted for rotation in the chamber. When engaged with the hub, the bur passes through a distal aperture in the housing. The housing is further provided with a port for introducing a fluid into the chamber substantially tangential to the axis. Also, the device includes disks connected to the hub and substantially perpendicular to the axis. Operationally, boundary layer effect forces between the fluid flow and the disks cause the hub and the bur to rotate about the axis.

### FIELD OF THE INVENTION

The present invention pertains generally to pneumatic handheld medical devices. More particularly, the present invention pertains to systems for reducing noise caused by pneumatic dental handpieces. The present invention is particularly, but not exclusively, useful as a pneumatic dental handpiece utilizing boundary layer effects for transferring energy from a pneumatic fluid to a bur to reduce operational noise.

### BACKGROUND OF THE INVENTION

As is well known, dentists often perform drilling and buffing procedures using handpieces that rotate a drill or bur. Also, surgeons use similar handpieces for non-dental operations. Typically, these handpieces are powered by electricity or by a pneumatic fluid. For various reasons, pneumatic powered handpieces are generally favored by dentists and surgeons. However, the pneumatic handpieces currently in use produce high pitch noises that often irritate patients during treatment. Specifically, these pneumatic handpieces utilize impulse turbines that rely on the impact between pressurized pneumatic fluid and rotors. As a result, these pneumatic handpieces produce ear-piercing high pitch noises at varying degrees at certain rotational speeds.

For operators, these high noise levels may cause permanent hearing loss from prolonged exposure. In fact, the subject of possible occupational hazard regarding these high pitch noises is currently being debated among dentists and dental hygienists. Nevertheless, pneumatic handpieces are still favored in dental practices due to their ability to deliver high torque in small handpieces.

In light of the above, it is an object of the present invention to provide a device that provides sufficient torque to a medical bur while exhibiting substantially reduced noise, relative to currently used impulse turbine pneumatic handpieces. More specifically, it is an object of the invention to provide a dental handpiece exhibiting a twelve to fifteen decibel reduction at free rotation, and an eight to ten decibel reduction under load, relative to current impulse turbine handpieces. Another object of the present invention is to provide a pneumatic handpiece that eliminates hazardous noise byproduct at all operating speeds. Still another object of the present invention is to provide a dental handpiece that transfers energy from a pneumatic fluid to a plurality of disks before the fluid impinges on any rotor surface. Yet another object of the present invention is to provide a dental handpiece that utilizes boundary layer effect forces to transfer energy from a pneumatic fluid to a rotating bur. Another object of the present invention is to provide a pneumatic handpiece that employs a plurality of thin disks mounted for rotation in a specialized air circuit to produce a required minimum power level at significantly reduced noise levels. Still another object of the present invention is to provide a dental handpiece exhibiting noise-reduction that is easy to implement, is simple to use, and is comparatively cost effective.

### SUMMARY OF THE INVENTION

In accordance with the present invention, a handheld pneumatic medical device for rotating a bur about an axis, such as a dental handpiece, exhibits a substantial reduction in noise. Similar to typical impulse turbine pneumatic dental handpieces, the device forces a pneumatic fluid into a chamber to drive a mechanism to rotate the bur. Importantly, the present device utilizes boundary layer effect forces to transfer energy from the pneumatic fluid to the bur when the fluid is introduced to the chamber. As a result, noise caused by the impingement of the fluid on the drive mechanism as the fluid enters the chamber is eliminated.

Structurally, the device includes a housing that forms the chamber in fluid communication with the pressurized fluid source. Further, the housing defines the axis of rotation and establishes a distal aperture and a proximal opening centered on the axis. Also, the housing forms an input port for introducing fluid into the chamber substantially tangential to the axis. Likewise, the housing forms at least one egress port to allow fluid to exit the chamber after its energy is transferred to rotation of the bur.

To connect the bur to the housing, the device includes a substantially cylindrical hub mounted in the housing for rotation about the axis. Structurally, the hub forms an axial channel to selectively receive and engage with the bur. More particularly, the hub includes a proximal engagement member positioned at the proximal opening for engagement with the bur. Further, the hub includes a distal engagement member positioned at the distal aperture in the housing for engagement with the bur. Also, the device is provided with a number of cooperating elements that ensure a fluid tight and rotatable connection between the bur and the housing. For instance, the device includes a chuck that interconnects the bur and the proximal engagement member. Also, the device includes a rotor mounted on the proximal engagement member and a corresponding stator mounted on the proximal opening of the housing. Further, the device provides for a rotor mounted on the distal engagement member and a corresponding stator mounted on the distal aperture. Accordingly, bearings are mounted between the corresponding rotors and stators to facilitate rotation of the bur within the housing.

In order to transfer energy from the fluid flow to the hub and bur, the device includes a plurality of disks connected to the hub. Specifically, the disks are equidistantly spaced and are substantially perpendicular to the axis. As a result, an inter-disk gap is formed between each pair of adjacent disks. For the present invention, fluid flowing into the chamber passes directly into the inter-disk gaps and follows a somewhat circular or spiral path about the axis until it exits through the egress port. As a result of this fluid flow, energy is transferred to the disks through boundary layer effect forces. More colloquially, the fluid drags the disks in the direction of flow through the friction forces on the disks' planar surfaces. In order to optimize the transfer of energy from the fluid to the disks, the surfaces of each disk may be roughened. Also, the outer edge of each disk may be chamfered to eliminate impingement of the fluid on each outer edge to further improve performance.

In a simplified embodiment of the device, each disk is mounted directly to the hub. Further, each disk forms a complete barrier between adjacent inter-disk gaps, i.e., there is not axial movement of fluid from one gap to another. In this embodiment, the egress port is preferably positioned within the same radial plane as the input port. More specifically, the egress port is located slightly less than 360 degrees downstream from the input port. As a result of this construction, fluid is injected into the chamber and enters the inter-disk gaps traveling tangentially to the axis. Thereafter, the fluid follows a somewhat circular path along the outer portions of the inter-disk gaps before exiting radially outward through the egress port. As may be understood, the fluid does not spiral radially inward in this simplified embodiment because no passageway is provided through the disks or the hub.

In another embodiment of the device, each disk is again mounted directly to the hub. However, in this embodiment, the hub is provided with a central portion that is distanced from the bur. In other words, a cylindrical pocket or central void is defined between the hub and the bur. Also, the central portion forms two or three passageways to interconnect the inter-disk gaps with the central void. Because the passageways extend axially beyond the terminal disks, they also interconnect the central void and the headspace (the space between the disks and the proximal and distal ends of the chamber). As a result, the flow path is established from the input port, spirally through the inter-disk gaps toward the axis, into and out of the central void through the passageways, and through the headspace to the egress port.

Another embodiment of the present invention creates the central void outside of the hub. Specifically, in this embodiment, the two terminal disks are mounted directly to the hub. The remaining intermediate disks are connected to the hub through the terminal disks. Specifically, an axially extending rod or shaft is used to connect the terminal disks to the intermediate disks. Further, the intermediate disks have inner edges defining an inner diameter that is greater than the outer diameter of the hub. As a result, the cylindrical central void is defined between the intermediate disks and the hub. In order to provide fluid communication between the central void and the headspaces, each terminal disk defines at least one passageway. As a result, the flow path is established from the input port, spirally through the inter-disk gaps toward the axis, into the central void, axially through the passageways, and radially outward through the headspace to the egress port.

In a modified embodiment, the device is provided with an additional mechanism for rotating the bur about the axis. Specifically, this embodiment of the device includes vanes for impingement by the fluid after the fluid has spiraled through the inter-disk gaps toward the axis. In this embodiment, each disk has an inner edge defining an inner diameter that is greater than the outer diameter of the cylindrical portion of the hub. However, the hub is further provided with an outer portion that comprises a plurality of vanes. Structurally, the vanes connect the inner edges of the disks to the central portion of the hub. Between each pair of adjacent vanes, a passageway is formed from the inter-disk gaps to the central portion of the hub. In this manner, a flow path is established from the input port, radially inward through the inter-disk gaps, and through a respective passageway to the headspace and the egress port. As noted, the vanes include a surface for impingement by the fluid flow after the fluid has traveled from the outer edge to the inner edge of each disk. As a result, additional forces are provided to rotate the hub and the bur about the axis. However, the impingement does not produce objectionable noise because the fluid energy is reduced after transferring energy to the disks while passing through the inter-disk gaps.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a dentist preparing to use a handheld pneumatic dental handpiece to perform a dental procedure on a patient in accordance with the present invention;

FIG. 2 is an elevation view of the dental handpiece of FIG. 1 with a portion exploded to illustrate internal features in the handpiece;

FIG. 3 is a cross sectional view of an embodiment of a dental handpiece in accordance with the present invention;

FIG. 4A is a cross sectional view of an alternate embodiment of a dental handpiece in accordance with the present invention;

FIG. 4B is a perspective view of a disk and an intermediate portion of a hub used in the embodiment of FIG. 4A;

FIG. 4C is a perspective view of an alternate disk and an intermediate portion of a hub used in the embodiment of FIG. 4A;

FIG. 5A is a cross sectional view of an alternate embodiment of a dental handpiece in accordance with the present invention;

FIG. 5B is an elevation view of an intermediate disk for use in the embodiment of FIG. 5A;

FIG. 5C is an elevation view of a terminal disk for use in the embodiment of FIG. 5A;

FIG. 6A is a cross sectional view of an alternate embodiment of a dental handpiece in accordance with the present invention;

FIG. 6B is a perspective view of the plurality of disks connected to the hub through a plurality of vanes in the embodiment of FIG. 6A; and

FIG. 7 is a graphical representation of noise levels exhibited by the dental handpiece compared to a typical impulse turbine handpiece in the prior art.

### DESCRIPTION OF THE PREFERRED EMBODIMENTS

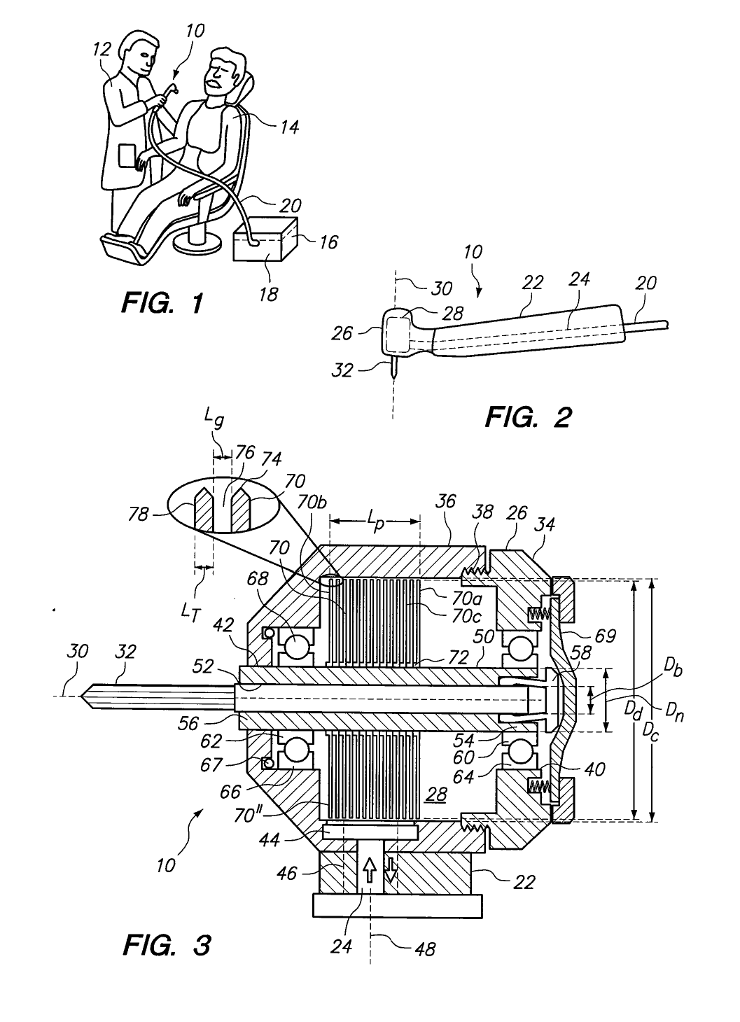

Referring initially to FIG. 1, a handheld pneumatic medical device is shown and generally designated 10. As shown in FIG. 1, the device 10 is a dental handpiece used by a dentist 12 to perform a dental procedure on a patient 14. As with typical pneumatic devices 10, the handpiece 10 is connected to a pressurized fluid source 16 for supplying a pneumatic fluid 18 via a fluid line 20.

Referring to FIG. 2, the structure of the handheld device 10 is more clearly illustrated. As shown, the device 10 includes a grip portion 22 that defines an internal lumen 24 for receiving the fluid line 20. Further, the device 10 includes a housing 26 that forms a cylindrical chamber 28 in communication with the lumen 24. For retrofit applications, the housing 26 is prepared to attach to an existing grip portion 22. Otherwise, the device 10 may be manufactured with a dedicated grip portion 22 and housing 26. As shown in FIG. 2, the chamber 28 defines an axis 30. Also, the chamber 28 receives a drill or bur 32 for rotation about the axis 30 to perform a dental procedure.

Referring to FIG. 3, the internal structure of an embodiment of the device 10 is shown. In FIG. 3, the housing 26 includes a proximal casing 34 and a distal casing 36 that include reciprocating threads 38 for selective engagement. As shown, the proximal casing 34 and the distal casing 36 cooperate to define the chamber 28. Also, the proximal casing 34 forms a proximal opening 40 centered about the axis 30. Likewise, the distal casing 36 forms a distal aperture 42 about the axis 30. Further, the distal casing 36 forms an input port 44 in fluid communication with the lumen 24 for injecting the fluid 18 into the chamber 28 substantially tangential to the axis 30. As shown in phantom, the distal casing 36 also forms an egress port 46 located slightly less than three-hundred and sixty degrees about the axis from the input port 44. In the embodiment shown, the input port 44 and egress port 46 are located in a same radial plane 48, perpendicular to the axis 30.

As shown in FIG. 3, the device 10 includes a substantially cylindrical hub 50 mounted in the chamber 28 for rotation about the axis 30. Structurally, the hub 50 forms an axial channel 52 to selectively receive and engage the bur 32. In FIG. 3, the hub 50 includes a proximal engagement member 54 positioned at the proximal opening 40 of the housing 26 to engage the bur 32. Further, the hub 50 includes a distal engagement member 56 positioned at the distal aperture 42 in the housing 26 for engagement with the bur 32. In the embodiment of FIG. 3, the hub 50 comprises a cylindrical sleeve which is integral with the proximal engagement member 54 and the distal engagement member 56.

Still referring to FIG. 3, it can be seen that the device 10 is provided with a chuck 58 that further anchors the bur 32 to the hub 50. Also, the device 10 includes a proximal rotor 60 and a distal rotor 62 that are mounted on the proximal and distal engagement members 54, 56, respectively. As shown, a proximal stator 64 and a distal stator 66 corresponding to the rotors 60, 62 are mounted on housing 26 at the proximal opening 40 and distal aperture 42, respectively. In order to facilitate rotation of the hub 50 and bur 32, the device 10 provides for bearings 68 at the interface of the rotors 60, 62 and stators 64, 66. To ensure that the device 10 is fluid tight, an O-ring 67 is positioned between the distal stator 66 and the housing 26. Also, a sealing mechanism 69 is provided at the proximal opening 40.

In order to drive the rotation of the hub 50 and bur 32, the device 10 includes a plurality of disks 70 mounted directly to the hub 50. Specifically, each disk 70 includes a circular inner edge 72 that is mounted on the hub 50. As shown, the disks 70 are positioned equidistantly from one another from a proximal terminal disk 70a to a distal terminal disk 70b. In FIG. 3, the device 10 includes the two terminal disks 70a, 70b and twelve intermediate disks 70c, however any number of disks 70 may be selected to provide the appropriate torque. Further, each disk 70 is substantially perpendicular to the axis 30 and extends radially from the inner edge 72 to a circular outer edge 74 that almost touches the housing 26. As shown in the exploded portion of FIG. 3, each pair of adjacent disks 70 defines an inter-disk gap 76. In the embodiment shown in FIG. 3, the disks 70 form a complete barrier between adjacent inter-disk gaps 76. In other words, each planar surface 78 of a disk 70 is continuous without interruption between its inner edge 72 and its outer edge 74.

As a result of this construction, when fluid 18 is injected into the chamber 28 through the input port 44, it enters the inter-disk gaps 76 traveling tangentially to the axis 30. Thereafter, the fluid 18 follows a somewhat circular path near the outer edges 74 of the disks 70 in the inter-disk gaps 76. Then, the fluid 18 exits the chamber 28 radially through the egress port 46. During the somewhat circular flow of the fluid 18, boundary layer effect forces transfer energy from the fluid 18 to the disks 70. As a result, the fluid 18 causes the disks 70, hub 50 and bur 32 to rotate about the axis 30. In order to maximize the transfer of energy between the fluid 18 and the disks 70, the surfaces 78 of the disks 70 are preferably roughened by sandblasting or other similar mechanical procedure.

As shown in the blown up portion of FIG. 3, the outer edges 74 of the disks 70 are chamfered to eliminate impingement between the fluid 18 and the outer edges 74 and to improve performance of the device 10. Further, each disk 70 has a thickness Lt of about 0.003 inches and each gap 76 has an axial length Lg of about 0.005 inches. In FIG. 3, other preferred dimensions are illustrated. For example, the length Lp of the plurality of disks 70 from the proximal surface 78 of the proximal terminal disk 70a to the distal surface 78 of the distal terminal disk 70b is approximately 0.18 inches. Further, the following diameters are illustrated: the diameter Db of the bur (and, accordingly the diameter of the channel 52) is about 0.062 inches; the outer diameter Dh of the hub (and, accordingly, the inner diameter of the disks 70) is about 0.125 inches; the outer diameter Dd of the disks 70 is about 0.425 inches; and the diameter Dc of the chamber 28 is about 0.427. As a result, there is a distance of about 0.01 inches between the outer edge 74 of each disk 70 and the housing 26.

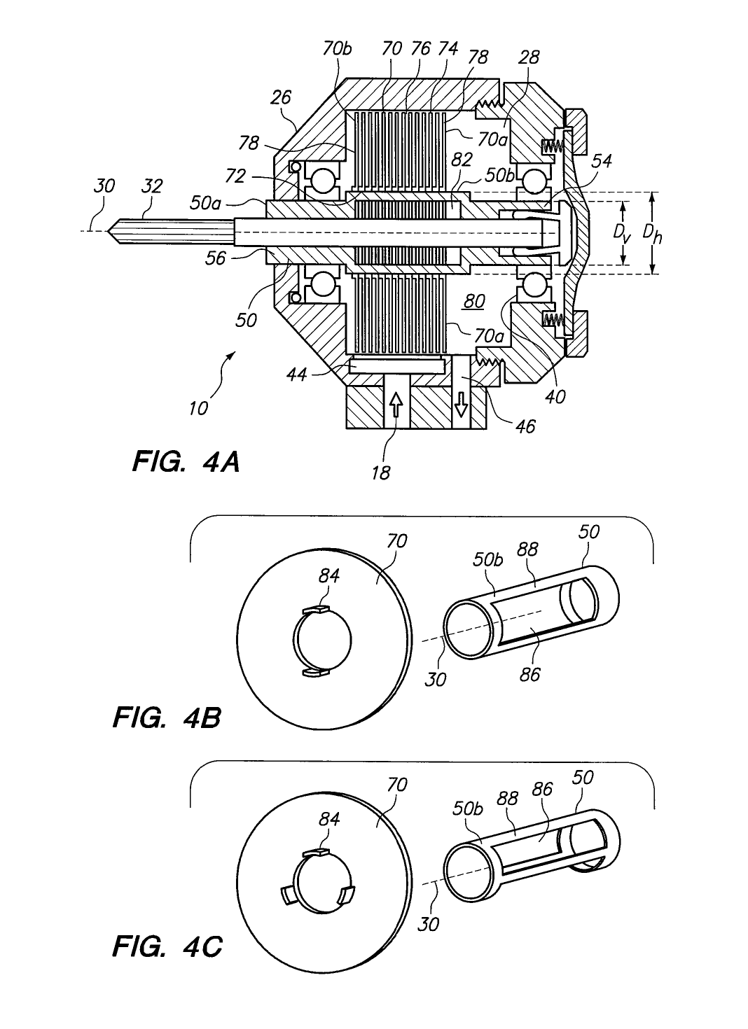

Referring now to FIG. 4A, another embodiment of the device 10 is illustrated. Upon initial inspection of FIG. 4A, it can be seen that the housing 26 is substantially the same as the housing 26 in FIG. 3. In fact, the only substantive difference between the housings 26 of the two embodiments is the location of the egress port 46. In the embodiment in FIG. 4A, the egress port 46 is positioned proximally of the input port 44. Also, as shown in FIG. 4A, the device 10 defines a proximal headspace 80 between the proximal terminal disk 70a and the proximal opening 40 in the housing 26. Importantly, the egress port 46 is in fluid communication with the proximal headspace 80. In fact, the egress port 46 may be positioned anywhere in the housing 26 as long as fluid communication with the headspace 80 is preserved. Further, there may be multiple egress ports 46, if desired.

In FIG. 4A, the hub 50 is shown to include a cylindrical portion 50a and an intermediate portion 50b. As shown, the cylindrical portion 50a comprises the proximal engagement member 54 and the distal engagement member 56, which are similar to the hub 50 of FIG. 3. However, the intermediate portion 50b in FIG. 4A is a key difference from the hub 50 of FIG. 3. As shown in FIG. 4A, the intermediate portion 50b also is cylindrical but, unlike the cylindrical portion 50a, its inner diameter is greater than the outer diameter of the bur 32. As a result, the device 10 defines a cylindrical pocket or central void 82 between the bur 32 and the intermediate portion 50b. In FIG. 4A, the outer diameter Dh of the intermediate portion 50b of the hub 50 is about 0.15 inches and the diameter Dv of the central void 82 (or the inner diameter of the hub 50) is about 0.125 inches. In accordance with the larger diameter of the intermediate portion 50b of the hub 50, the inner edges 72 of the disks 70 also have the diameter Dh and can be said to define the central void 82. While not expressly labeled in FIG. 4A, each disk 70 has a thickness Lt of about 0.003 inches and each gap 76 has an axial length Lg of about 0.005 inches. Further, the length Lp of the plurality of disks 70 from the proximal surface 78 of the proximal terminal disk 70a to the distal surface 78 of the distal terminal disk 70b is approximately 0.18 inches. Also, the diameter Db of the bur is about 0.062 inches; the outer diameter Dd of the disks 70 is about 0.425 inches; and the diameter Dc of the chamber 28 is about 0.427 inches. As a result, there is a distance of about 0.01 inches between the outer edge 74 of each disk 70 and the housing 26.

Referring to FIGS. 4B and 4C, the interconnection between the disks 70 and the intermediate portion 50b of the hub 50 may be understood. As shown, each disk 70 includes axially-extending legs 84 to provide a strong connection to the hub 50. Further, each leg 84 abuts an adjacent disk 70 to facilitate proper installation of the disks 70 on the hub 50. As shown in FIGS. 4B and 4C, the intermediate portion 50b of the hub 50 includes a plurality of passageways 86. In FIG. 4B, the intermediate portion 50b of the hub 50 includes two passageways 86 that are positioned opposite from one another about the axis 30. Accordingly, two axially-extending mounting strips 88 remain for mounting the corresponding two legs 84 of the disk 70. Alternatively, in FIG. 4C, the intermediate portion 50b of the hub 50 includes three passageways 86 positioned at one-hundred-and-twenty degree intervals about the axis 30. Therefore, the intermediate portion 50b in FIG. 4C provides three axially-extending mounting strips 88 that correspond to the legs 84 of the disk 70 in FIG. 4C.

With the structure of the intermediate portion 50b of the hub 50 in mind, the pathway of fluid 18 through the device 10 in FIG. 4A may be understood. Initially, fluid 18 is introduced by the input port 44 into the chamber 28 tangential to the axis 30. Virtually all of the fluid 18 flowing into the chamber 28 enters an inter-disk gap 76. As the boundary layer effect forces transfer energy from the fluid flow to the disks 70, the fluid 18 slows and spirals radially inward through the inter-disk gaps 76 toward the axis 30. As the fluid 18 reaches the intermediate portion 50b of the hub 50, it passes through a passageway 86 and enters the central void 82. Thereafter, the fluid 18 moves proximally through the central void 82 and passes into the proximal headspace 80 through the passageway 86. At that point, the fluid 18 may exit the chamber 28 through the egress port 46.

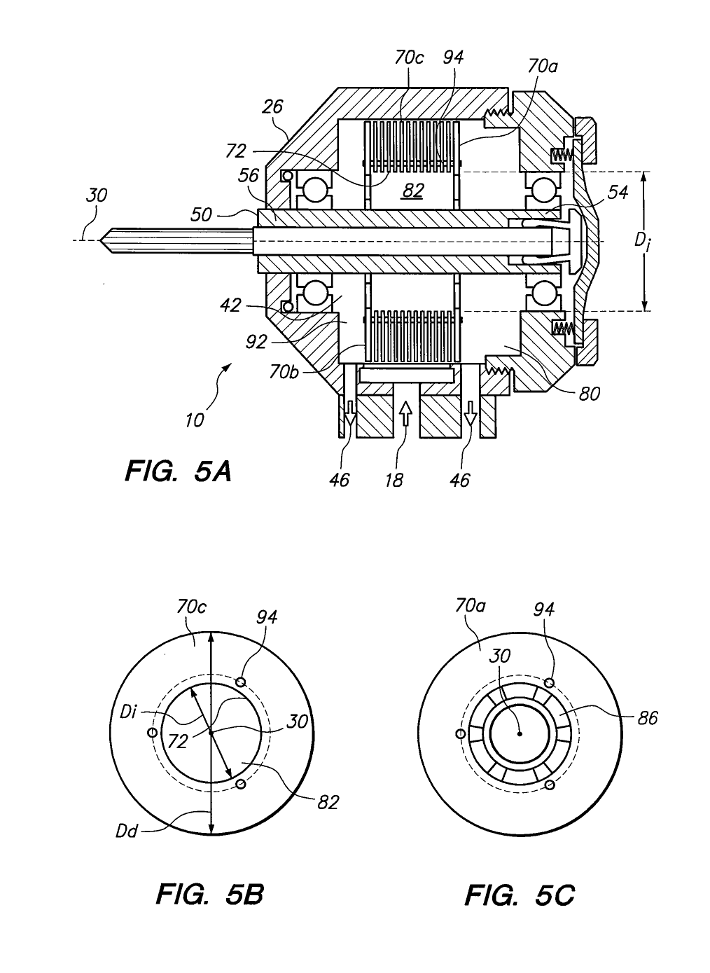

Referring now to FIG. 5A, another embodiment of the device 10 is illustrated. Unlike the embodiments of FIGS. 3 and 4A, the housing 26 in FIG. 5A forms two egress ports 46. Further, the device 10 in FIG. 5A defines a distal headspace 92 located between the distal terminal disk 70b and the distal aperture 42. As shown, each egress port 46 is in fluid communication with a respective headspace 80, 92.

In FIG. 5A, the hub 50 is cylindrical and includes integral proximal and distal engagement members 54, 56, similar to the device 10 of FIG. 3. Further, the proximal and distal terminal disks 70a, 70b are directly mounted to the hub 50. However, none of the intermediate disks 70c are directly mounted to the hub 50. Instead, each of the intermediate disks 70c has an inner diameter Di that is greater than the outer diameter Dh of the hub 50. In particular, the intermediate disks' inner diameter Di is about 0.20 inches and the hub's outer diameter Dh (labeled in FIG. 3) is about 0.125 inches. As a result, the device 10 defines a central void 82 between the hub 50 and the intermediate disks 70c.

In order to connect the intermediate disks 70c to the hub 50, the device 10 includes a plurality of support rods or bars 94 that are substantially parallel to the axis 30. Preferably, the support rods 94 are located approximately 0.125 inches radially outward from the inner edge 72 of the intermediate disks 70c. Referring to FIGS. 5B and 5C, it may be seen that the device 10 includes three support rods 94 positioned equidistantly about the axis 30. In FIG. 5B, the structure of an intermediate disk 70c is more clearly illustrated. As shown, the intermediate disk 70c has an inner edge 72 defining the inner diameter Di of about 0.20 inches. Likewise, the outer edge 74 of the intermediate disks 70c defines the outer diameter Dd of about 0.425 inches.

While not expressly illustrated in FIG. 5A, each disk 70 has a thickness Lt of about 0.003 inches and each gap 76 has an axial length Lg of about 0.005 inches. Further, the length Lp of the plurality of disks 70 from the proximal surface 78 of the proximal terminal disk 70a to the distal surface 78 of the distal terminal disk 70b is approximately 0.2 inches. Also, the diameter Db of the bur (and, accordingly the diameter of the channel 52) is about 0.062 inches; and the diameter Dc of the chamber 28 is about 0.427 inches. As a result, there is a distance of about 0.01 inches between the outer edge 74 of each disk 70 and the housing 26.

Referring to FIG. 5C, the structure of the terminal disks 70a, 70b may be understood. As shown, exemplary terminal disk 70a forms six passageways 86. As may be understood from cross-referencing FIG. 5C with FIG. 5B, these passageways 86 overlie the central void 82 defined by the intermediate disks 70c.

Referring back to FIG. 5A, the flow path of the fluid 18 in this embodiment of the device 10 may be understood. Again, the fluid 18 is initially introduced by the input port 44 into the chamber 28 tangential to the axis 30. Virtually all of the fluid 18 flowing into the chamber 28 enters an inter-disk gap 76. As the boundary layer effect forces transfer energy from the fluid flow to the disks 70, the fluid 18 slows and spirals radially inward through the inter-disk gaps 76 toward the axis 30. As the fluid 18 passes the inner edges 72 of the intermediate disks 70c, it enters the central void 82. Thereafter, the fluid 18 may flow proximally or distally toward a respective headspace 80, 92. Then, the fluid 18 passes from the headspace 80, 92 through the respective egress port 46.

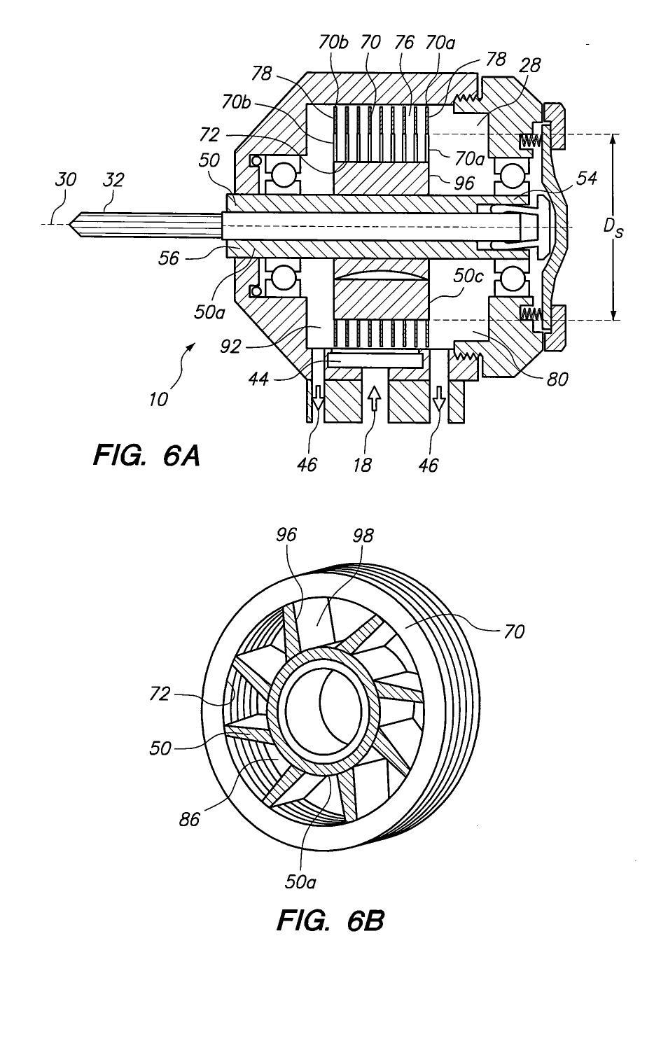

Turning to FIG. 6A, a final embodiment of the device 10 may be understood. As shown, the device 10 in FIG. 6A includes two egress ports 46 that are in communication with a respective headspace 80, 92. Importantly, the device 10 of FIG. 6A includes a modified hub 50. Specifically, in addition to the cylindrical portion 50a that forms the distal and proximal engagement members 54, 56, the hub 50 includes an outer portion 50c comprising a plurality of vanes 96. As shown in FIG. 6A, each vane 96 extends axially from the proximal terminal disk 70a to the distal terminal disk 70b. Referring to FIG. 6B, the structure of the vanes 96 may be understood. As shown, each vane 96 includes a surface 98 that slopes with the direction of the flow path. As seen in FIGS. 6A and 6B, the inner edge 72 of all disks 70 is mounted directly to each vane 96 and is distanced from the central cylindrical portion 50a of the hub 50. Therefore, an axially-extending passageway 86 is formed between each pair of adjacent vanes 96.

In FIG. 6A, the vanes 96 have an outer diameter Dv (and the disks 70 have an inner diameter) of about 0.355 inches. While not expressly illustrated in FIG. 6A, each disk 70 has a thickness Lt of about 0.005 inches and each gap 76 has an axial length Lg of about 0.016 inches. Further, the length Lp of the plurality of disks 70 from the proximal surface 78 of the proximal terminal disk 70a to the distal surface 78 of the distal terminal disk 70b is approximately 0.11 inches. Also, the diameter Db of the bur 32 (and, accordingly, the diameter of the channel 52) is about 0.062 inches; and the diameter Dc of the chamber 28 is about 0.427 inches. As a result, there is a distance of about 0.01 inches between the outer edge 74 of each disk 70 and the housing 26. Also, the hub portion 50a has an outer diameter Dh of about 0.125 inches.

In view of the structure of the device 10 in FIGS. 6A and 6B, the operation of the device 10 may be understood. In FIG. 6A, the fluid 18 is initially introduced by the input port 44 into the chamber 28 tangential to the axis 30. Virtually all of the fluid 18 flowing into the chamber 28 enters an inter-disk gap 76. As the boundary layer effect forces transfer energy from the fluid flow to the disks 70, the fluid 18 slows and spirals radially inward through the inter-disk gaps 76 toward the axis 30. As the fluid 18 passes the inner edges 72 of the intermediate disks 70c, it impinges on the surface 98 of a respective vane 96. As a result, energy remaining in the fluid flow is transferred to the hub 50 through impingement with the vanes 96. Thereafter, the fluid 18 flows through the passageways 86 toward a respective headspace 80, 92. Then the fluid 18 exits the chamber 28 through an egress port 46. As can be seen, this embodiment of the device 10 is provided with an additional mechanism of energy transfer through impingement of the fluid 18 on the vanes 96. It is noted that only low levels of noise are created through this impingement because the flow of fluid 18 has slowed significantly due to the boundary layer effect forces.

Cross-referencing FIGS. 5A-5C with FIG. 6B, it may be understood that the support rods 94 may be shaped like the vanes 96 to provide for some impingement of the fluid 18 upon the vanes 96. Further, such vane-shaped support rods 94 may extend radially to connect to the hub 50. In such an embodiment, the proximal and distal terminal disks 70a, 70b need not be directly mounted to the hub 50, instead they may be identical to the intermediate disks 70c.

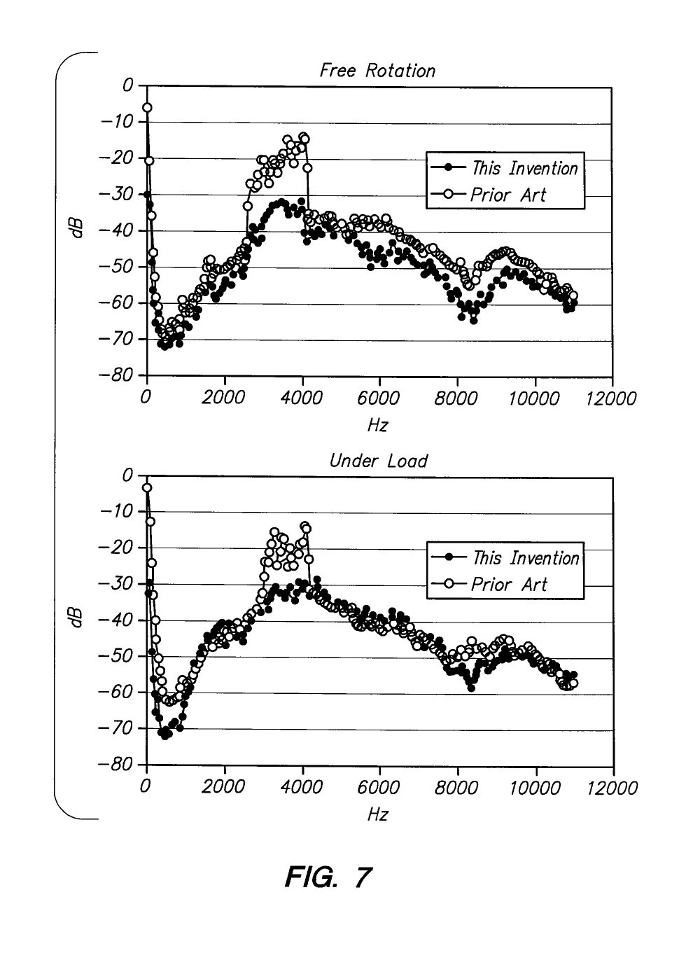

Referring now to FIG. 7, the performance of the dental handpiece 10 may be compared to an impulse turbine handpiece of the prior art. As shown, the dental handpiece 10 exhibits superior noise reduction over the important frequency range of 3000 to 4000 Hz. Under free rotation, the dental handpiece 10 limits noise to twelve to fifteen decibels lower than the prior art device. Further, under load, the dental handpiece 10 produces noise at a level of eight to ten decibels lower than the prior art device.

While the particular Pneumatic Handheld Medical Device with Reduced Noise as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A handheld medical device for rotating a bur about an axis which comprises:
a housing defining a chamber, wherein the housing forms a distal aperture about the axis for receiving the bur, and wherein the housing forms an input port for introducing a flow of fluid into the chamber substantially tangential to the axis;
a hub mounted in the housing for rotation about the axis, said hub forming an axial channel for selective engagement with the bur; and
a plurality of disks connected to the hub and substantially perpendicular to the axis, wherein boundary layer effect forces between the fluid flow and the disks cause the hub and the bur to rotate about the axis.

2. A device as recited in claim 1 wherein the housing forms a proximal opening about the axis, wherein the hub includes a proximal engagement member positioned at the proximal opening for engagement with the bur, wherein the hub includes a distal engagement member positioned at the distal aperture in the housing for engagement with the bur, and wherein the device further comprises:
a chuck interconnecting the bur and the proximal engagement member;
a rotor mounted on the proximal engagement member;
a stator mounted on the proximal opening;
a plurality of bearings mounted between the proximal rotor and the proximal stator to facilitate rotation of the bur within the proximal opening;
a rotor mounted on the distal engagement member;
a stator mounted on the distal aperture; and
a plurality of bearings mounted between the distal rotor and the distal stator to facilitate rotation of the bur within the distal aperture.

3. A device as recited in claim 2 wherein the housing is formed from a distal casing and a proximal casing, wherein said distal casing forms the distal aperture, the input port, and an egress port, wherein said proximal casing forms the proximal opening, and wherein said distal casing and said proximal casing conjunctively define the chamber.

4. A device as recited in claim 1 wherein each disk has a proximal and distal surface, and wherein the surfaces are roughened to increase the boundary layer effect.

5. A device as recited in claim 1 wherein each disk has a chamfered outer edge.

6. A device as recited in claim 1 wherein an inter-disk gap is formed between each pair of adjacent disks, wherein the fluid flows into the inter-disk gaps from the input port, and wherein the fluid flows out of the chamber through an egress port formed in the housing.

7. A device as recited in claim 6 wherein each disk is mounted directly to the hub, wherein the input port and the egress port are on a same radial plane perpendicular to the axis, and wherein fluid flows from the input port radially into each inter-disk gap and then radially out of each inter-disk gap and out of the egress port.

8. A device as recited in claim 6 wherein the plurality of disks includes a proximal disk, a distal disk, and intermediate disks positioned equidistantly therebetween, wherein a proximal headspace is defined in the chamber between the proximal disk and the housing, and wherein a distal headspace is defined in the chamber between the distal disk and the housing.

9. A device as recited in claim 8 wherein the hub includes an intermediate portion that is distanced from the bur to define a central void therebetween, wherein the intermediate portion of the hub forms at least one passageway to interconnect the inter-disk gaps with the central void and to interconnect the central void with the headspace to establish a flow path from the input port, radially inward through the inter-disk gaps, and through the central void to the egress port.

10. A device as recited in claim 9 wherein each disk has an outer diameter and wherein the central void has a diameter of about 25% to 75% of the outer diameter.

11. A device as recited in claim 8 wherein at least two disks are mounted directly to the hub, wherein the remaining disks are connected to the hub through the directly-mounted disks, wherein a central void is defined between the remaining disks and the hub, and wherein the directly-mounted disks define at least one passageway to interconnect the central void and at least one of the headspaces to establish a flow path from the input port, radially inward through the inter-disk gaps, and through the central void to the egress port.

12. A device as recited in claim 11 wherein each disk has an outer diameter and wherein the central void has a diameter of about 35% to 75% of the outer diameter.

13. A device as recited in claim 8 wherein the hub includes a cylindrical central portion and an outer portion comprising a plurality of vanes interconnecting the central portion of the hub and the disks, with each vane having a surface for impingement by the fluid flowing radially through the inter-disk gaps to increase rotation of the hub and the bur about the axis.

14. A device as recited in claim 13 wherein, between each pair of adjacent vanes, a passageway is formed from the inter-disk gaps to the central portion of the hub to establish a flow path from the input port, radially inward through the inter-disk gaps, and through a respective passageway to the egress port.

15. A device as recited in claim 14 wherein each disk has an outer diameter, and wherein each disk has an inner diameter of about 45% to 85% of the outer diameter.

16. A noise-reducing adapter for a handheld medical device that pneumatically rotates a bur about an axis which comprises:
a housing defining a chamber, wherein the housing forms a distal aperture about the axis for receiving the bur;
a hub mounted in the housing for rotation about the axis;
a means for engaging the bur with the hub;
a plurality of substantially planar disks connected to the hub to define a plurality of inter-disk gaps, with each disk having an outer edge and being substantially perpendicular to the axis; and
a means for introducing a flow of fluid into the chamber substantially tangential to the axis, wherein boundary layer effect forces between the disks and the fluid flow through the inter-disk gaps cause the hub and the bur to rotate about the axis.

17. An adapter as recited in claim 16 wherein the disks form a central void centered about the axis to establish a spiral flow path from the outer edges of the disks to the central void.

18. An adapter as recited in claim 16 wherein the disks have an inner edge and wherein the hub includes a cylindrical central portion and an outer portion comprising a plurality of vanes interconnecting the central portion of the hub and the disks, with each vane having a surface for impingement by the fluid flowing radially through the inter-disk gaps to increase rotation of the hub and the bur about the axis.

19. A noise-reducing adapter for a handheld pneumatic medical device which comprises:
a housing mountable on the device, said housing defining a chamber and an axis, wherein the housing forms a distal aperture about the axis;
a hub mounted in the chamber for rotation about the axis;
a means for engaging the hub with a bur, with the bur extending through the distal aperture for a procedure;
a plurality of substantially planar disks connected to the hub to define a plurality of inter-disk gaps;
a means for introducing a flow of fluid into the inter-disk gaps tangential to the axis; and
a boundary-layer-effect means for converting flow of the fluid through the inter-disk gaps to rotation of the hub about the axis.

20. An adapter as recited in claim 19 wherein the adapter forms a void centered about the axis and in fluid communication with the inter-disk gaps to establish a radially-inward spiral flow path in the inter-disk gaps to the central void.
